(19) United States
(12) Patent Application Publication
(10) Pub. No.: US 2002/0019756 A1
(43) Pub. Date: Feb. 14, 2002

(54) Charter aircraft network organization, reservation, and flight processing system and method

(76) Inventor: Richard C. Greenough, Bloomfield Hills, MI (US)

Correspondence Address: Jeffrey A. Sadowski, HOWARD & HOWARD, Suite 101, 39400 Woodward Avenue, Bloomfield Hills, MI, 48304-2856, US

(21) Appl. No.: 09/904,064

(22) Filed: Jul. 12, 2001

Related U.S. Application Data
(60) Provisional application No. 60/218,475, filed on Jul. 14, 2000.

(51) Int. Cl. G06F 17/60

(52) U.S. Cl. 705/5

(57) ABSTRACT

A system and method arranges air transportation. The system and method receives a request for a flight from a customer. The system and method searches a composite database and determines an air transportation solution as a function of the request. The composite database contains information related to available flights by air charter companies.

### CROSS-REFERENCE TO RELATED APPLICATIONS

This application claims the benefit of U.S. Provisional Patent Application Serial No. 60/218,475, filed Jul. 14, 2000.

### FIELD OF THE INVENTION

The present invention is related generally to charter air services, and more particularly, to a method and system for providing air transportation on charter air services.

### BACKGROUND OF THE INVENTION

Air travel can be frustrating and expensive. Airports are over crowded. Commercial airliners are frequently delayed or cancelled. Flights are commonly overbooked.

One alternative to commercial airline travel is charter air service. However, in general, the general public is not aware of the availability of charter air service and/or it is believed to be too expensive.

Charter air services provide air travel service in relatively small aircraft. The service provider may have one or more small planes which may make regular trips between a destination and a place of origin or a trip may be scheduled based on the customer's needs. Occasionally, the trips are one way, i.e., the aircraft is flown to a destination at which the passenger(s) or freight or package(s) disembark. Then the aircraft may be flown back empty. This could also happen in reverse, i.e., the aircraft is flown to a destination empty. Then the passenger(s) or freight or package(s) board the aircraft, which is then flown back. In addition, there may be seats or other spaces on the aircraft which are not utilized.

Thus, even though the charter flight may be completely paid for by the chartering party, the empty seats on both legs of the round trip flight present an opportunity for additional revenue for the charter operators or savings for the chartering party.

An early attempt to create revenue from these opportunities, involved an outside party which contacted charter services and tracked the availability of seats in card files. The seats were then sold to the public. This presented several problems. First, the card catalog was inflexible in the manner in which the data could be organized. For example, if the potential client wanted to get to a particular destination, the card files presented no way in which to quickly search by a destination which might be within the general routing of the potential client's request.

Additionally, the card file system did not lend itself well for presentation to the public. The target audience or potential customer did not have access to the data except through contacting the company and having the card files manually searched.

The present invention is aimed at one or more of the problems identified above.

### SUMMARY OF THE INVENTION AND ADVANTAGES

In one aspect of the present invention, a method for arranging air transportation is provided. The method includes the steps of receiving a request for a flight from a customer, searching a composite database, and determining an air travel solution as a function of the request. The composite database contains information related to available flights by multiple charter companies.

In another aspect of the present invention, a computer based method for arranging for air transportation over a computer network or other communication method is provided. The method includes the steps of receiving a request for a flight from a customer at a remote location and delivering the request from the remote location to a central location over the computer network or other communication method. The method further includes the step of searching a composite database and determining an air transportation solution as a function of the request. The composite database contains information related to available flights by multiple charter companies, and transportation requests by customers.

In still another aspect of the present invention, a computer system for arranging air transportation over a computer network, is provided. The system includes a first module located at a remote location. The system receives a request for a flight from a customer at a remote location. A second module is coupled to the first module. The second module is located at a central location and includes a composite database. The second module is adapted to receive the request from the remote location, search the composite database and determine an air transportation solution as a function of the request.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram of a system for arranging air transportation, according to an embodiment of the present invention;

FIG. 2 is a flow diagram of a method for arranging air transportation; and,

FIG. 3 is a flow diagram of a method for arranging air transportation over a computer network.

### DETAILED DESCRIPTION OF THE INVENTION

Referring to the Figs., wherein like numerals indicate like or corresponding parts throughout the several views, a system 100 for arranging air transportation over a computer network, is provided.

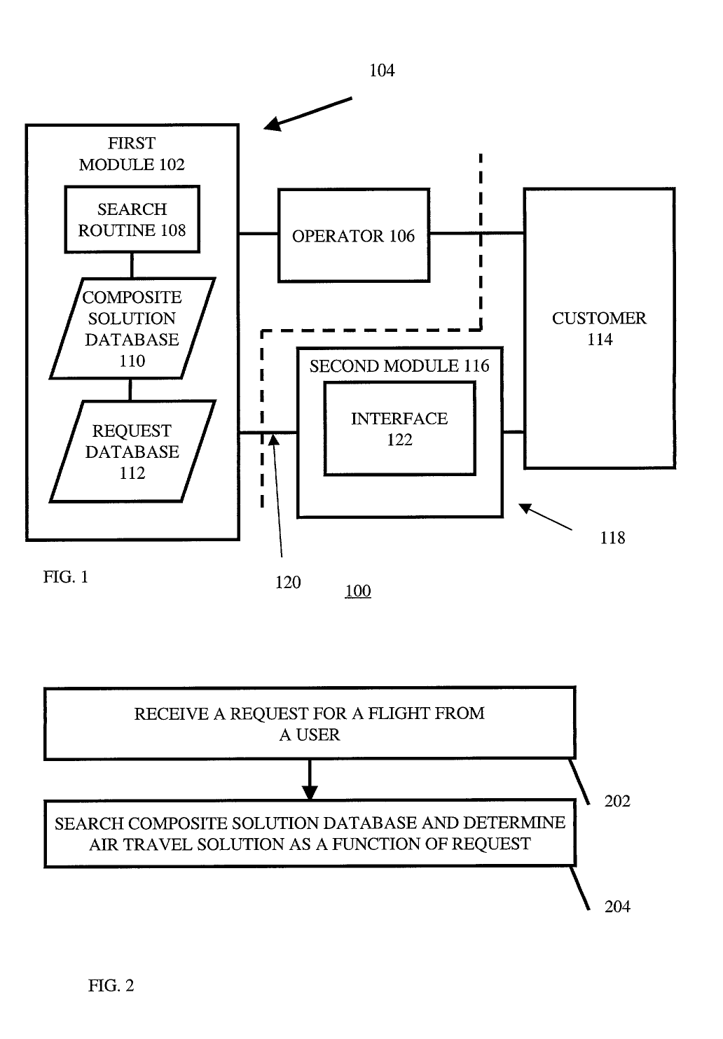

With particular reference to FIG. 1, in a first embodiment, the system 100 includes a first module 102 located at a central location 104. Preferably, the first module 102 is implemented on a computer (not shown), such as a mainframe computer, personal computer, wireless computing device, or other suitable computing device. The first module 102 is adapted to be operated by an operator 106. As discussed below, the first module 102 includes a search routine 108, a composite solution database 110, and a request database 112.

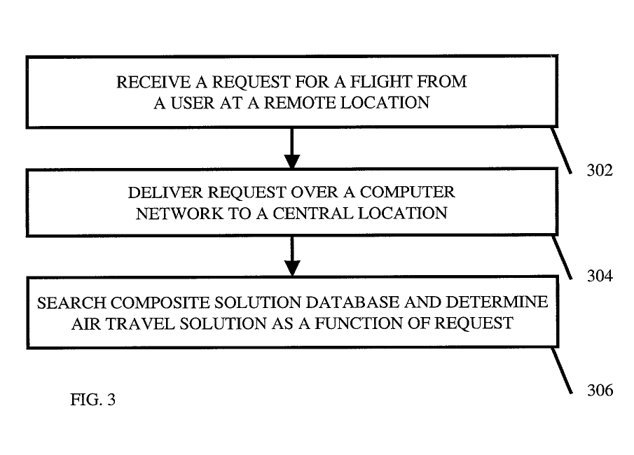

With reference to FIG. 2, a method 200 for arranging air transportation, including the steps of receiving a request for a flight from a customer 114, searching the composite database 110, and identifying potential air transportation solutions as a function of the request. The composite database 110 contains information related to existing or potential charter flights by multiple charter companies. In one embodiment, the multiple charter companies are participating or member charter companies.

The request may be sent to the operators 106 by any convenient method, such as email, a facsimile, or telephone. The operator 106 having received a request, utilizes the search engine 108 to search the database 110 for potential matches.

Preferably, the charter flights stored in the composite database are organized using a geographic coding system. In one embodiment, the geographic coding system includes first, second, third, and fourth codes. The first code is representative of an airport. The second code is representative of a county. The third code is representative of a group of counties. The fourth code is representative of a state. In another embodiment, the geographic coding system may include codes representative of location latitude and longitude, either directly or indirectly, for example using zip or postal codes.

Returning to FIG. 1, in another embodiment, the system 100 includes a second module 116 located at a remote location 118, such as a customer or customer site. Preferably, the second module 116 is implemented on a computer (not shown), such as a personal computer or wireless computing device. The second module 116 is adapted to be operated by the customer or user 114.

Preferably, the database 110 is searchable by destination and/or origin.

Preferably, the potential air transportation solution is based on the geographic coding system. The potential air transportation solution may be an exact match in terms of destination and/or origin.

The potential air transportation solution may not be an exact match. The potential air transportation solution may be a near match, i.e., the destination and/or origin is near the desired route or destination or origin or generally within the desired route.

The customer 114 inputs a request for a flight to the second module 116. The request includes at least a destination or an origin. Additionally, the request may include other flight details.

The first and second computer based modules 102, 116 are coupled across a computer network 120. In the preferred embodiment, the computer network 120 is the internet and the first computer based module 102 is located at a facility wherein the system 100 is maintained.

The first module 102 receives the request from the customer 114 via the second module 116 and the computer network 120 or directly from the customer 114. The first module 102 includes the composite database 110 and the search routine 108. The composite database 110 contains information relating to existing or potential charter flights by participating charter companies. The search routine 108 is adapted to search the composite solution database 110 and identify potential air transportation solutions as a function of the request.

With reference to FIG. 3, a computer based method for arranging air transportation over a computer network will now be explained. In a first control block 302, a request for a flight from the customer 114 is received at a remote location 118. In a second control block 304, the request is delivered over the computer network 120 from the remote location 118 to the central location 104. In a third control block 306, the composite database 110 is searched and a potential air transportation solution is identified as a function of the request. The composite database 110 contains information related to existing or potential charter flights by participating charter companies. Participating charter companies are typically otherwise unaffiliated and operate a single aircraft or multiple aircraft.

A customer interface 122 is implemented on the second module 116 located at the remote location 118. The customer interface 122 allows the customer 114 to log on to the system 100 and to communicate with the system 100, e.g., to request flights and to receive air transportation solutions from the system 100. The customer interface 122 is preferably graphical in nature, and, preferably, is accessed through a generic world wide web (WWW) browser, such as Microsoft™ Internet Explorer, available from Microsoft of Redmond, Wash. The customer interface 122 may be implemented in hyper text markup language (HTML), the JAVA language, and may include JavaScript.

The customer interface 122 also provides access to the available flights within the composite database 110. Preferably, the flight data is sorted by date and destination or date and origin. Any other sorting may also be used. This information is also accessible by telephone.

The request may include a preferred destination. The requests are preferably stored in the request database 112. The request database 112 is searchable and may be accessible by the participating charter companies. If a match between the available flights and the request does not exist, the operator can create a flight based on the requests stored in the request database.

Fees or commissions are generated in conjunction with the air transportation solution and may be paid by a user of the system or method. In one embodiment, the fee is a function of the transportation cost associated with the air transportation solution. The air transportation solution may be selected and purchased via the customer interface 122. The cost of the air transportation solution and the associated fees may also be paid via the customer interface 122.

In one embodiment, the air transportation solution is created from available space on the existing or potential charter flights. The available space may include empty flights, such as the outbound or return flight, or a created segment within the outbound or return flight, from an already chartered flight or empty space on an already chartered flight.

The air transportation solution is delivered to the customer 114 at the remote location 118 over the computer network 120. In one embodiment, the air transportation solution is delivered using electronic mail. In another embodiment, the air transportation solution is delivered using fax or voice messaging or telephones.

In one embodiment, the service (as embodied in the method and system 100) is a subscription service. In other words, the participating charter operators and/or users of the system 100 pay a subscription fee. The subscription fee may be a single payment or a periodic fee due, e.g., monthly or yearly dues, or a fee calculated using any suitable formulation.

Obviously, many modifications and variations of the present invention are possible in light of the above teachings.

What is claimed is:

1. A method for arranging air transportation, including the steps of:
receiving a request for a flight from a customer; and,
searching a composite database and identifying a potential air transportation solution as a function of the request, the composite database containing information related to available flights by multiple air charter companies.

2. A method, set forth in claim 1, wherein the multiple air charter companies are participating air charter companies.

3. A method, as set forth in claim 1, wherein the composite database is searchable by destination and/or origin.

4. The method, as set forth in claim 1, wherein the request is sent from a customer via email, a facsimile, telephone, and/or other communication method.

5. The method, as set forth in claim 1, wherein the request includes a preferred destination and/or origin.

6. The method, as set forth in claim 1, wherein the air transportation solution includes a travel cost and/or a departure time and/or an arrival time.

7. The method, as set forth in claim 1, wherein the air transportation solution includes a name of a participating charter company.

8. The method, as set forth in claim 1, including the step of receiving a fee or commission on the air transportation solution.

9. The method, as set forth in claim 8, wherein the fee or commission is a function of a cost associated with the air transportation solution.

10. The method, as set forth in claim 1, wherein the air transportation solution is created from available space on the charter flights.

11. The method, as set forth in claim 10, wherein the available space includes empty flights.

12. The method, as set forth in claim 10, wherein the available space includes empty seats.

13. The method, as set forth in claim 1, including the step of including information related to flight requests of customers.

14. The method, as set forth in claim 1, wherein the air charter companies pay a membership fee.

15. The method, as set forth in claim 14, wherein the customer pays a membership fee.

16. The method, as set forth in claim 1, including the step of storing the request in a request database.

17. The method, as set forth in claim 16, including the step of creating a charter flight to fulfill the request.

18. The method, as set forth in claim 1, wherein the available flights stored in the composite database are organized using a geographic coding system.

19. The method, as set forth in claim 18, wherein the potential air transportation solution is based on the geographic coding system.

20. The method, as set forth in claim 19, wherein the geographic coding solution allows for inexact matches.

21. The method, as set forth in claim 1, wherein the potential air transportation solution is not an exact match.

22. The method, as set forth in claim 18, wherein the geographic coding system includes a first code representative of an airport.

23. The method, as set forth in claim 22, wherein the geographic coding system includes a second code representative of a county.

24. The method, as set forth in claim 23, wherein the geographic coding system includes a third code representative of a group of counties.

25. The method, as set forth in claim 24, wherein the geographic coding system includes a fourth code representative of a state.

26. A method for arranging air transportation for a person, including the steps of:
receiving a request for a flight from a customer;
searching a composite database and determining an air transportation solution as a function of the request, the composite database containing information related to available space on charter flights by multiple charter companies; and,
receiving a fee or commission on the air transportation solution.

27. The method, set forth in claim 26, wherein the multiple charter companies are participating charter companies.

28. The method, as set forth in claim 26, wherein the composite database is searchable by destination and/or origin.

29. A computer based method for arranging air transportation over a computer network, including the steps of:
receiving a request for a flight from a customer at a remote location;
delivering the request from the remote location to a central location over the computer network; and,
searching a composite database and determining an air transportation solution as a function of the request, the composite database containing information related to available flights by individual charter operators.

30. The computer based method, set forth in claim 29, wherein the charter operators are participating air charter companies.

31. The computer based method, as set forth in claim 29, wherein the composite database is searchable by destination and/or origin.

32. The computer based method, as set forth in claim 29, wherein the request includes a preferred destination and/or origin.

33. The computer based method, as set forth in claim 29, wherein the air transportation solution includes a travel cost and/or a departure time and/or an arrival time.

34. The computer based method, as set forth in claim 29, wherein the air transportation solution includes a name of a participating charter company.

35. The computer based method, as set forth in claim 29, including the step of receiving a fee or commission on the air transportation solution.

36. The computer based method, as set forth in claim 35, wherein the fee or commission is a function of a cost associated with the air transportation solution.

37. The computer based method, as set forth in claim 29, wherein the air transportation solution is created from available space on the charter flights.

38. The computer based method, as set forth in claim 37, wherein the available space includes empty flights.

39. The computer based method, as set forth in claim 37, wherein the available space includes empty seats.

40. The computer based method, as set forth in claim 29, including the step of delivering the air transportation solution to the customer at the remote location over the computer network.

41. The computer based method, as set forth in claim 29, including the step of providing a customer interface at the remote location.

42. The computer based method, as set forth in claim 29, including the step of providing access to the computer network to subscribers, wherein the customer is a subscriber.

43. The computer based method, as set forth in claim 29, including the step of including information related to flight requests of customers.

44. The computer based method, as set forth in claim 43, wherein the customers pay a membership fee.

45. The computer based method, as set forth in claim 29, wherein the charter companies pay a membership fee.

46. The computer based method, as set forth in claim 29, including the step of storing the request in a request database.

47. The computer based method, as set forth in claim 46, including the step of creating a charter flight to fulfill the request.

48. A computer based method for arranging air transportation over a computer network, including the steps of:
receiving a request for a flight from a customer at a remote location;
delivering the request from the remote location to a central location over the computer network;
searching a composite database and identifying a potential air transportation solution as a function of the request, the composite database containing information related to available space on available flights by multiple charter companies; and,
receiving a fee or commission on the air transportation solution.

49. The computer based method, set forth in claim 48, wherein the multiple charter companies are participating air charter companies.

50. The computer based method, as set forth in claim 48, wherein the composite database is searchable by destination and/or origin.

51. A computer system for arranging air transportation over a computer network, comprising:
a first module located at a remote location and being adapted to receive a request for a flight from a customer at a remote location; and,
a second module coupled to the first module and being located at a central location, the second module including a composite database and being adapted to receive the request from the remote location, search the composite database and determine an air transportation solution as a function of the request, the composite database containing information related to available flights by individual charter operators.

52. The computer system, as set forth in claim 51, wherein the charter operators are participating air charter companies.

53. The computer system, as set forth in claim 51, wherein the composite database is searchable by destination and/or origin.

54. The computer system, as set forth in claim 51, wherein the request includes a preferred destination and/or origin.

55. The computer system, as set forth in claim 51, wherein the air transportation solution includes a travel cost and/or a departure time and/or an arrival time.

56. The computer system, as set forth in claim 51, wherein the air transportation solution includes a name of a participating charter company.

57. The computer system, as set forth in claim 51, wherein a fee or commission is received on the air transportation solution.

58. The computer system, as set forth in claim 57, wherein the fee or commission is a function of a cost associated with the air transportation solution.

59. The computer system, as set forth in claim 51, wherein the air transportation solution is created from available space on the charter flights.

60. The computer system, as set forth in claim 59, wherein the available space includes empty flights.

61. The computer system, as set forth in claim 59, wherein the available space includes empty seats.

62. The computer system, as set forth in claim 51, including a customer interface implemented on the first module.

63. The computer system, as set forth in claim 62, where the customer interface provides access to the composite database.

64. The computer system, as set forth in claim 51, wherein access is only provided to subscribers, wherein the customer is a subscriber.

65. The computer system, as set forth in claim 51, wherein full access is only provided to subscribers and limited access is provided to non-subscribers.

66. The computer system, as set forth in claim 51, wherein information related to flight requests of customers is included.

67. The computer system, as set forth in claim 66, wherein the customers pay a membership fee.

68. The computer system, as set forth in claim 51, wherein the request is stored in a request database.

69. A computer system for arranging air transportation over a computer network, comprising:
a first module located at a remote location and being adapted to receive a request for a flight from a customer at a remote location; and,
a second module coupled to the first module and being located at a central location, the second module including a composite database and being adapted to receive the request from the remote location, search the composite database and identify at least one potential air transportation solution as a function of the request, the composite database containing information related to available space on available flights by multiple charter companies, wherein a fee is received on the air transportation solution.

70. The computer system, set forth in claim 69, wherein the multiple charter companies are participating air charter companies.

71. The computer system, as set forth in claim 69, wherein the composite database is searchable by destination and/or origin.

72. The method, as set forth in claim 29, wherein the geographic coding system identifies arrival and departure locations by longitude and latitude.

73. The method, as set forth in claim 72, wherein the geographic coding system identifies locations directly.

74. The method, as set forth in claim 72, wherein the geographic coding system identifies locations indirectly.

75. The method, as set forth in claim 29, wherein the available flights stored in the composite database are identified using a geographic coding system.

76. The method, as set forth in claim 75, wherein the potential air transportation solution is based on the geographic coding system.

77. The method, as set forth in claim 76, wherein the geographic coding solution allows for inexact matches.

78. The method, as set forth in claim 69, wherein the potential air transportation solution is not an exact match.

79. The method, as set forth in claim 51, wherein the available flights stored in the composite database are identified using a geographic coding system.

80. The method, as set forth in claim 79, wherein the potential air transportation solution is based on the geographic coding system.

81. The method, as set forth in claim 80, wherein the geographic coding solution allows for inexact matches.

82. The method, as set forth in claim 5140, wherein the potential air transportation solution is not an exact match.
